(19) United States
(12) Patent Application Publication
(10) Pub. No.: US 2025/0208001 A1
(43) Pub. Date: Jun. 26, 2025

(54) TIRE GROOVE MEASURING DEVICE, TIRE GROOVE MEASURING SYSTEM, AND TRIE GROOVE MEASURING METHOD

(71) Applicant: PERSOL AVC TECHNOLOGY CO., LTD., Takatsuki City, Osaka (JP)

(72) Inventors: Kazuhiro UMEZAWA, Takatsuki City, Osaka (JP); Nobumichi TAKABA, Takatsuki City, Osaka (JP)

(21) Appl. No.: 18/852,261

(22) PCT Filed: Mar. 30, 2022
(86) PCT No.: PCT/JP2022/016010

§ 371 Date: Sep. 27, 2024

(51) Int. Cl. G01M 17/02; G01B 11/22

(52) U.S. Cl. CPC G01M 17/027; G01B 11/22

(57) ABSTRACT

A tire groove measuring device that a user moves along a tread of a tire to measure grooves provided in the tread of the tire. The tire groove measuring device includes: a distance sensor that detects a distance between the tire and the tire groove measuring device; and a processing device that calculates depths of the grooves based on output data of the distance sensor. The processing device is configured to: detect candidate grooves based on output data of the distance sensor; select a first groove with a deepest depth from among the plurality of candidate grooves; select, as candidate main grooves, grooves whose depth is within a first predetermined value Q with respect to the depth of the first groove from among the candidate grooves; and select a shallowest depth value from among depths of the candidate main grooves.

### TECHNICAL FIELD

The present invention relates to a tire groove measuring device, a tire groove measuring system, and a tire groove measuring method.

### BACKGROUND ART

Tires mounted on vehicles such as automobiles have grooves in their treads. As the tire wears as the vehicle runs, the depths of the grooves become shallower, and therefore, there is a need to measure the depths of the grooves and manage the condition of the tire.

Patent Document 1 discloses a measuring device for measuring grooves on a tire tread. The measuring device is fixed to the ground as a car stop in a parking space. Patent document 1 discloses a technique for measuring tire grooves while a vehicle is parked so that the tire contacts the measuring device, which is a car stop.

### CITATION LIST

### Patent Literature

Patent Document No. 1: Japanese Laid-Open Patent Publication No. 2019-086293

### SUMMARY OF INVENTION

### Technical Problem

Since the measuring device of Patent Document 1 is fixed to the ground, the measurement of grooves can only be performed at the location where the measuring device is installed. It is also necessary to move the vehicle so that the tire is positioned in a predetermined position at a predetermined angle. Patent Document 1 fails to disclose how to process the output data of the laser displacement sensor that measures the tire grooves to manage the remaining amount of grooves.

There is a need to improve user convenience with respect to the measurement of tire grooves.

### Solution to Problem

The tire groove measuring device according to one embodiment of the present invention is a hand-held tire groove measuring device that a user moves along a tread of a tire to measure grooves provided in the tread of the tire, including: a distance sensor that detects a distance between the tire and the tire groove measuring device; and a processing device that calculates depths of the grooves based on output data of the distance sensor, wherein: the tread of the tire is provided with main grooves having a tread wear indicator and sub-grooves not having a tread wear indicator; and the processing device is configured to: detect candidate grooves based on the output data of the distance sensor; select a first groove with a deepest depth from among the plurality of candidate grooves; select, as candidate main grooves, grooves whose depth is within a first predetermined value with respect to the depth of the first groove from among the candidate grooves; and select a shallowest depth value from among depths of the candidate main grooves.

The tire groove measuring device according to one embodiment of the present invention is a hand-held tire groove measuring device that the user moves along the tread of the tire. The grooves can be measured while the vehicle is stopped at an arbitrary location, and it is therefore possible to improve the user convenience.

According to one embodiment of the present invention, it is possible to detect the depth of the shallowest main groove from among the main grooves and the sub-grooves provided in the tread. By selecting candidate main grooves from among a plurality of candidate grooves, it is possible to suppress the detection of the depth of a sub-groove as the depth of the shallowest main groove. By being able to determine the remaining amount of the main groove provided with the tread wear indicator, it is possible to appropriately manage the condition of the tire.

The user can easily manage the condition of the tire as there is no need for the user to look at the output data of the distance sensor, find the shallowest main groove and determine its depth.

In one embodiment, the processing device may be configured to: estimate a position where an amount of increase in distance indicated by the output data is equal to a second predetermined value as a position of a start edge of a groove; and estimate a position where an amount of decrease in distance indicated by the output data is equal to a third predetermined value as a position of an end edge of the groove.

Thus, it is possible to detect a plurality of candidate grooves using the output data of the distance sensor.

In one embodiment, the processing device may be configured to: calculate an average value between a distance at the start edge and a distance at the end edge indicated by the output data; and calculate, as a depth of the groove, a difference between the average value and a distance at a position between the start edge and the end edge where the distance is greatest.

Thus, it is possible to calculate the depths of a plurality of candidate grooves.

In one embodiment, the processing device may be configured to: update the second and third predetermined values to a value obtained by multiplying the depth of the first groove by a first predetermined ratio; and re-estimate the positions of the start edge and the end edge of the groove using the updated second and third predetermined values.

Thus, it is possible to more accurately select candidate main grooves from among a plurality of candidate grooves.

In one embodiment, the processing device may be configured to: update the plurality of candidate grooves based on the positions of the start edge and the end edge of the grooves estimated using the updated second and third predetermined values; and select, as candidate main grooves, grooves whose depth is within the first predetermined value with respect to the depth of the first groove.

Thus, it is possible to more accurately select candidate main grooves.

In one embodiment, the processing device may be configured to: calculate a difference between a depth of a first-detected groove and a depth of a last-detected groove, from among the plurality of candidate grooves; correct depth values of the plurality of candidate grooves based on the difference between the depth of the first-detected groove and the depth of the last-detected groove; and select candidate main grooves based on the corrected depths of the plurality of candidate grooves.

Thus, it is possible to suppress the shallowest main groove from being excluded from candidate main grooves even when the tire is unevenly worn.

In one embodiment, the tire groove measuring device may further include an inertial sensor that detects movement of the tire groove measuring device, wherein the processing device corrects the output data of the distance sensor based on output data of the inertial sensor.

From the output data of the inertial sensor, it is possible to calculate the amount of movement of the tire groove measuring device and detect the degree of tilt of the tire groove measuring device. By correcting the output data of the distance sensor using the output data of the inertial sensor, it is possible to reduce the disturbance of the measurement data caused by vibration, hand shake, etc., of the tire groove measuring device during the scan.

In one embodiment, the distance sensor may be a laser distance sensor.

Thus, there is no need to insert a probe such as a gauge into the grooves of the tire, and it is possible to measure the grooves of the tire with high accuracy in a short time.

The tire groove measuring system according to one embodiment of the present invention is a tire groove measuring system that measures grooves provided in a tread of a tire using a hand-held tire groove measuring device that a user moves along the tread of the tire, including: a distance sensor provided in the tire groove measuring device that detects a distance between the tire and the tire groove measuring device; and a processing device that calculates depths of the grooves based on output data of the distance sensor, wherein: the tread of the tire is provided with main grooves having a tread wear indicator and sub-grooves not having a tread wear indicator; and the processing device is configured to: detect a plurality of candidate grooves based on the output data of the distance sensor; select a first groove with a deepest depth from among the plurality of candidate grooves; select, as candidate main grooves, grooves whose depth is within a first predetermined value with respect to the depth of the first groove from among the candidate grooves; and select a shallowest depth value from among depths of the candidate main grooves.

The tire groove measuring device according to one embodiment of the present invention is a hand-held tire groove measuring device that the user moves along the tread of the tire. The grooves can be measured while the vehicle is stopped at an arbitrary location, and it is therefore possible to improve the user convenience.

According to one embodiment of the present invention, it is possible to detect the depth of the shallowest main groove from among the main grooves and the sub-grooves provided in the tread. By selecting candidate main grooves from among a plurality of candidate grooves, it is possible to suppress the detection of the depth of a sub-groove as the depth of the shallowest main groove. By being able to determine the remaining amount of the main groove provided with the tread wear indicator, it is possible to appropriately manage the condition of the tire.

The user can easily manage the condition of the tire as there is no need for the user to look at the output data of the distance sensor, find the shallowest main groove and determine its depth.

The tire groove measuring method according to one embodiment of the present invention is a tire groove measuring method that measures grooves provided in a tread of a tire by using a hand-held tire groove measuring device that a user moves along the tread of the tire, wherein: the tread of the tire is provided with main grooves having a tread wear indicator and sub-grooves not having a tread wear indicator; and the tire groove measuring method includes: detecting a distance between the tire and the tire groove measuring device using a distance sensor; detecting a plurality of candidate grooves based on output data of the distance sensor; selecting a first groove with a deepest depth from among the plurality of candidate grooves; selecting, as candidate main grooves, grooves whose depth is within a first predetermined value with respect to the depth of the first groove from among the candidate grooves; and selecting a shallowest depth value from among depths of the candidate main grooves.

The tire groove measuring device according to one embodiment of the present invention is a hand-held tire groove measuring device that the user moves along the tread of the tire. The grooves can be measured while the vehicle is stopped at an arbitrary location, and it is therefore possible to improve the user convenience.

According to one embodiment of the present invention, it is possible to detect the depth of the shallowest main groove from among the main grooves and the sub-grooves provided in the tread. By selecting candidate main grooves from among a plurality of candidate grooves, it is possible to suppress the detection of the depth of a sub-groove as the depth of the shallowest main groove. By being able to determine the remaining amount of the main groove provided with the tread wear indicator, it is possible to appropriately manage the condition of the tire.

The user can easily manage the condition of the tire as there is no need for the user to look at the output data of the distance sensor, find the shallowest main groove and determine its depth.

### Advantageous Effects of Invention

A tire groove measuring device according to one embodiment of the present invention is a hand-held tire groove measuring device that the user moves along the tread of the tire. Grooves can be measured while the vehicle is stopped at an arbitrary location, and it is therefore possible to improve the user convenience.

According to one embodiment of the present invention, it is possible to detect the depth of the shallowest main groove from among the main grooves and sub-grooves provided in the tread. By selecting candidate main grooves from among a plurality of candidate grooves, it is possible to suppress the detection of the depth of a sub-groove as the depth of the shallowest main groove. By being able to determine the remaining depth of the main groove with the tread wear indicator, it is possible to appropriately manage the condition of the tire.

The user can easily manage the condition of the tire because there is no need to look at the output data of the distance sensor, find the shallowest main groove and determine its depth.

### BRIEF DESCRIPTION OF DRAWINGS

FIG. 1 is a view showing how grooves 40 of a tire 30 are scanned by a tire groove measuring device 1 according to an embodiment of the present invention.

FIG. 2 is a block diagram showing the tire groove measuring device 1 according to an embodiment of the present invention.

FIG. 3 is a flow chart showing the process of detecting the depth of the shallowest main groove 41 from among a plurality of grooves 40 according to an embodiment of the present invention.

FIG. 4 is a view showing the process of detecting start edges and end edges of the grooves 40 according to an embodiment of the present invention.

FIG. 5(a) to FIG. 5(c) are views showing the process of calculating the depth of a candidate groove 40 according to an embodiment of the present invention.

FIG. 6 is a view showing the offset process in the detection of the depth of main grooves 41 according to an embodiment of the present invention.

FIG. 7 is a view showing the offset process in the detection of the depth of main grooves 41 according to an embodiment of the present invention.

FIG. 8 is a block diagram showing a tire groove measuring system 100 according to an embodiment of the present invention.

### DESCRIPTION OF EMBODIMENTS

An embodiment of the present invention will now be described with reference to the drawings. Like reference signs denote like elements, and redundant descriptions will be omitted. The following embodiment is illustrative, and the present invention is not limited thereto.

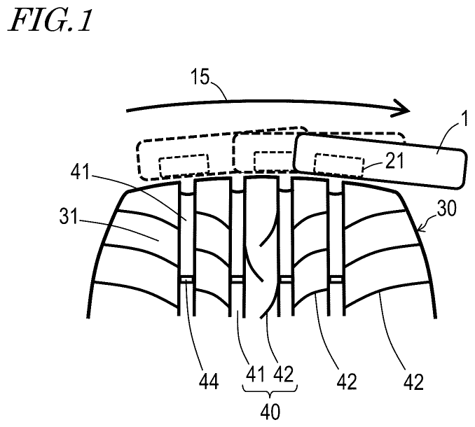

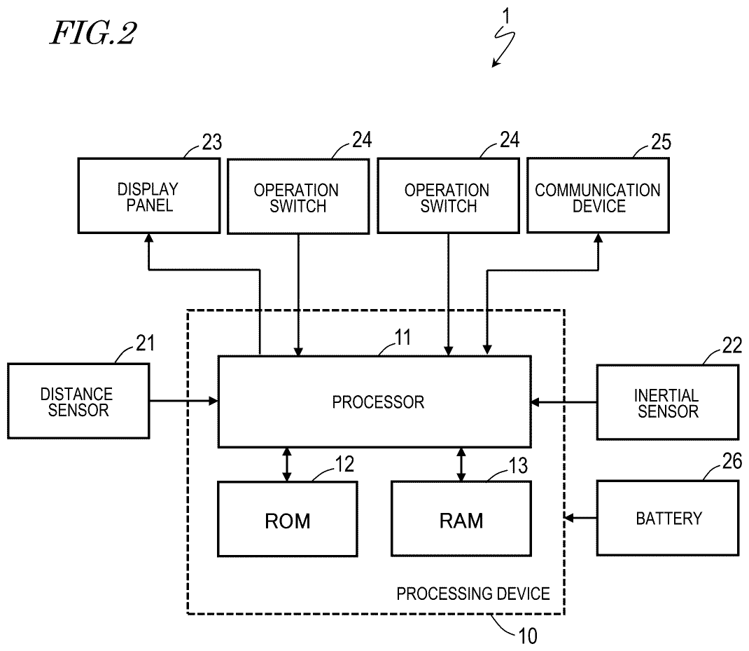

FIG. 1 is a view showing a tire groove measuring device 1 according to an embodiment of the present invention scanning grooves 40 of a tire 30. FIG. 2 is a block diagram showing the tire groove measuring device 1 of the present embodiment.

A plurality of grooves 40 are provided on a tread 31 of the tire 30. The plurality of grooves 40 include main grooves 41 and sub-grooves 42. The main groove 41 is a groove that is provided with a tread wear indicator 44. The tread wear indicator 44 may be a protrusion provided in the groove. The sub-groove 42 is a groove that is not provided with the tread wear indicator 44. The main groove 41 may be referred to as a groove, and the sub-groove 42 may be referred to as a slit and/or a sipe. Typically, the depth of the sub-groove 42 may be shallower than the depth of the main groove 41.

The tire groove measuring device 1 of the present embodiment is a hand-held tire groove measuring device that is held by the user to be moved along the tread 31 of the tire 30 to measure the grooves 40. The tire groove measuring device 1 includes a distance sensor 21. The user can scan the tread 31 provided with the grooves 40 by moving the tire groove measuring device 1 along the surface of the tread 31 with the distance sensor 21 facing the tread 31. When scanning, the user moves the tire groove measuring device 1 along the surface of the tread 31 while keeping the tire groove measuring device 1 in contact with the tread 31. The tire groove measuring device 1 may also be moved without being in contact with the tread 31. The arrow 15 shows an example of the direction in which the tire groove measuring device 1 is moved.

The distance sensor 21 is, for example, a laser distance sensor. The distance sensor 21 irradiates a laser beam onto the tread 31 provided with the grooves 40 and detects the distance between the tire 30 and the tire groove measuring device 1 by receiving the reflected light. The distance measuring method may be any method known in the art. While the distance measuring method may be a triangulation method, the measurement method is not limited thereto. By using a laser distance sensor as the distance sensor 21, there is no need to insert a probe such as a gauge into grooves 40, and it is possible to measure the grooves 40 with high accuracy in a short time.

As described above, the tire groove measuring device 1 is a hand-held tire groove measuring device that the user moves along the tread 31 of the tire 30. The grooves 40 can be measured while the vehicle is stopped at an arbitrary location, and it is therefore possible to improve the user convenience.

As shown in FIG. 2, the tire groove measuring device 1 includes a processing device 10, the distance sensor 21, an inertial sensor 22, a display panel 23, a plurality of operation switches 24, a communication device 25, and a battery 26. The battery 26 supplies power to the components of the tire groove measuring device 1.

The processing device 10 includes a processor 11 and recording media such as a ROM (Read Only Memory) 12 and a RAM (Random Access Memory) 13. A computer program (or firmware) that causes the processor 11 to perform processes may be stored in the ROM 12. The computer program may be provided to the tire groove measuring device 1 via a storage medium (e.g., a semiconductor memory or an optical disc) or an electrical communication line (e.g., the Internet). Such a computer program may be sold as commercial software.

The processor 11 is a semiconductor integrated circuit, and includes a central processing device (CPU), for example. The processor 11 sequentially executes the computer program stored in the ROM 12, which describes a group of instructions for executing various processes, to achieve desired processes.

The ROM 12 is, for example, a writable memory (e.g., a PROM), a rewritable memory (e.g., a flash memory), or a read-only memory. The ROM 12 stores a computer program that controls the operation of processor 11. The RAM 13 provides a work area for temporarily expanding the computer program stored in the ROM 12 at boot time.

The processor 11 executes the process of calculating the depth of the grooves 40 based on the output data of the distance sensor 21.

The distance sensor 21 irradiates a laser beam onto the tread 31 provided with the grooves 40, and detects the distance between the tire 30 and the tire groove measuring device 1. The distance sensor 21 outputs data including information regarding the detected distance to the processor 11.

The inertial sensor 22 includes an acceleration sensor, an angular acceleration sensor, a magnetic sensor, etc., and outputs signals indicating the amount of movement, the orientation and the attitude. The inertial sensor 22 can output signals indicating various quantities such as acceleration, speed, displacement, orientation, and attitude of the tire groove measuring device 1.

The tire groove measuring device 1 includes a plurality of operation switches 24. The tire groove measuring device 1 may include three or more operation switches 24. The user can operate the operation switches 24 to turn ON/OFF the power of the tire groove measuring device 1, perform an operation of starting and ending the scan, switch the display content of the display panel 23, exchange data with external devices, etc.

The display panel 23 displays various information in response to the user's operation of the tire groove measuring device 1. The display panel 23 is, for example, an LCD panel. The processor 11 causes the display panel 23 to display information such as the operating status of the tire groove measuring device 1, information indicating the measurement results of the grooves 40, and the remaining battery capacity. The display panel 23 may be a display panel other than an LCD panel, such as an OLED (Organic Light-Emitting Diode) panel or an electronic paper panel.

The communication device 25 performs data communication between the tire groove measuring device 1 and an external device. For example, the communication device 25 transmits information regarding the depth of the grooves calculated by the processor 11 to the external device. The communication device 25 is capable of wired communication and/or wireless communication. The communication device 25 can perform wired communication in accordance with communication standards such as USB, IEEE1394 (registered trademark), or Ethernet (registered trademark), for example. The communication device 25 can perform wireless communication in accordance with the Bluetooth (registered trademark) standard and/or the Wi-Fi (registered trademark) standard, for example. The communication device 25 may perform wireless communication using a mobile telephone line.

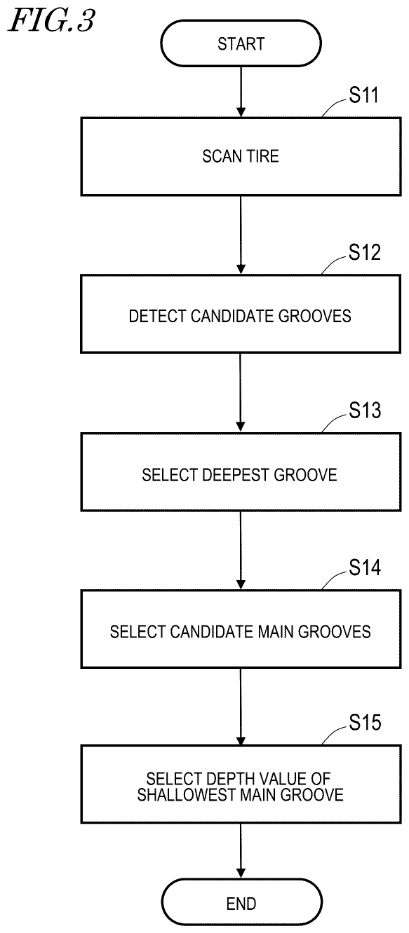

Next, the process of detecting the depth of the shallowest main groove 41 from among a plurality of grooves 40 provided in the tire 30. FIG. 3 is a flow chart showing the process of detecting the depth of the shallowest main groove 41 from among a plurality of grooves 40.

First, the tread 31 of the tire 30 provided with a plurality of grooves 40 is scanned (Step S11). The scanning operation of the tread 31 is as described above using FIG. 1. During the scanning operation, the distance sensor 21 irradiates a laser beam onto the tread 31 and detects the distance between the tire 30 and the tire groove measuring device 1 by receiving the reflected light. The processor 11 uses the output data of the inertial sensor 22 to calculate the amount of movement of the tire groove measuring device 1 during the scanning operation and the degree of tilt of the tire groove measuring device 1. The processor 11 can obtain data on the distance between each position along the scan line on the tread 31 provided with the grooves 40 and the tire groove measuring device 1 using the output data of the distance sensor 21 and the inertial sensor 22.

The processor 11 can correct the output data of the distance sensor 21 based on the output data of the inertial sensor 22. By correcting the output data of the distance sensor 21 using the output data of the inertial sensor 22, it is possible to reduce the disturbance of the measurement data caused by vibration, hand shake, etc., of the tire groove measuring device 1 during the scan. The processor 11 generates measurement data of the tread 31 provided with the grooves 40 using the output data of the distance sensor 21 and the inertial sensor 22.

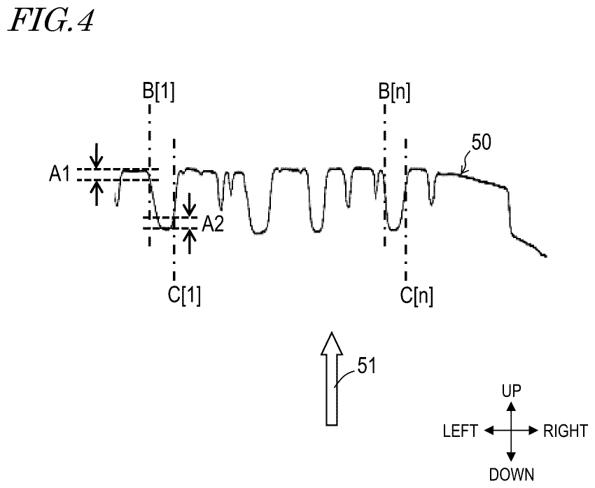

FIG. 4 shows an example of measurement data 50 of the tread 31 provided with the grooves 40. The left-right direction of the measurement data 50 shown in the figure may be a direction that is generally along the surface of the tread 31 in the width direction of the tire 30. The up-down direction of the measurement data 50 may be a direction that is generally along the radial direction of the tire 30. The height direction 51 is a direction that is along the up-down direction. A position with a smaller distance from the tire groove measuring device 1 can be a position with a larger height. The measurement data 50 can represent the cross-sectional shape of the tread 31 along the scan line. The relative height relationship between the tread 31 and the plurality of grooves 40 can be obtained from the data of the distance between the tire 30 and the tire groove measuring device 1. For the sake of clarity, the following description may focus on the height of the tread 31 and the height of each of the plurality of grooves 40.

The processor 11 detects candidate grooves 40 from the measurement data 50 (Step S12). FIG. 4 is a view showing the process of detecting start edges and end edges of the grooves 40.

The processor 11 estimates the position of the start edge B[n] of the groove 40 as the position where the increase in distance indicated by the measurement data 50 is equal to the predetermined value A1 (the second predetermined value) (n is an integer of 1 or more). An increase in distance indicated by the measurement data 50 corresponds to a decrease in height.

For example, the minimum value of the distance over a section of a predetermined length in the scanning direction (the left-right direction in FIG. 4) along the surface of the tread 31 is used as a reference, and the processor 11 estimates the position of the start edge B[n] as the position where the increase from the reference distance is equal to the predetermined value A1. The section of the predetermined length is 0.5 mm to 1.0 mm, for example, but is not limited thereto. The predetermined value A1 is 0.2 mm to 1.0 mm, for example, but is not limited thereto. Here, the predetermined value A1 is 0.2 mm as an example.

The processor 11 estimates the position of the end edge C[n] of the groove 40 as the position where the decrease in distance indicated by measurement data 50 is equal to the predetermined value A2 (the third predetermined value). A decrease in distance indicated by the measurement data 50 corresponds to an increase in height.

For example, the maximum value of the distance over a section of a predetermined length in the scanning direction (the left-right direction in FIG. 4) along the surface of the tread 31 is used as a reference, and the processor 11 estimates the position of the end edge C[n] as the position where the decrease from the reference distance is equal to the predetermined value A2. The predetermined value A2 is 0.2 mm to 1.0 mm, for example, but is not limited thereto. The predetermined value A1 and the predetermined value A2 may be the same value. Here, the predetermined value A2 is 0.2 mm as an example.

The processor 11 detects a plurality of start edges B[n] and end edges C[n] from the measurement data 50. The area starting from the start edge B[n] and ending at the end edge C[n] can be a candidate groove 40.

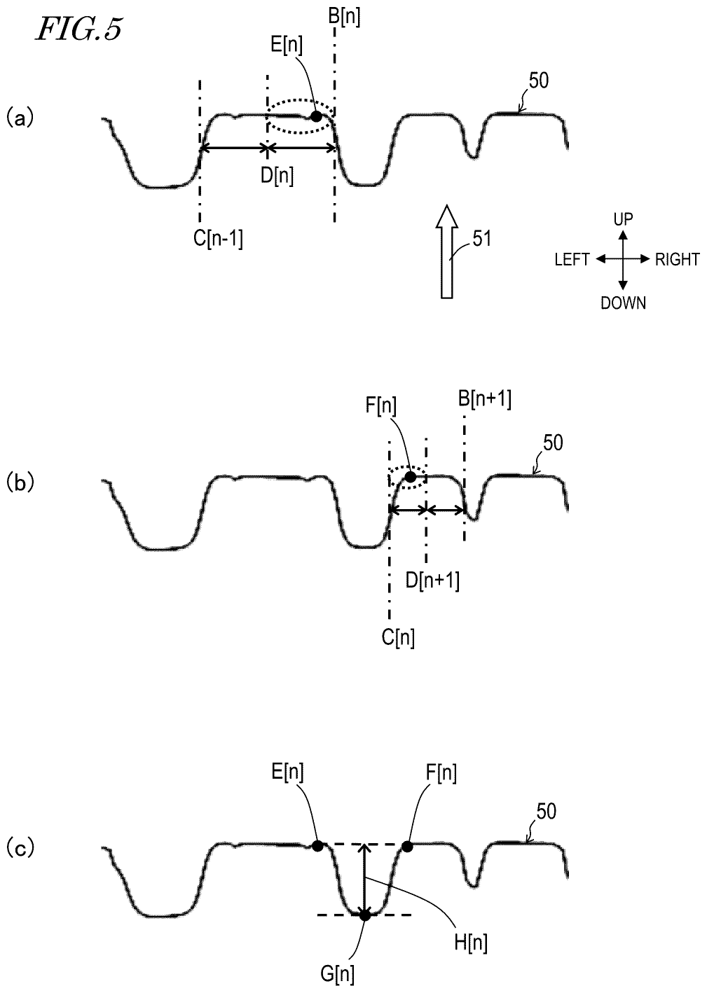

Next, the processor 11 calculates the depths of the candidate grooves 40. FIG. 5 is views showing the process of calculating the depths of the candidate grooves 40.

The processor 11 calculates the average value between the distance at the start edge B[n] and the distance at the end edge C[n] indicated by the measurement data 50. The depth of the groove 40 is calculated as the difference between the calculated average value and the distance value at a position between the start edge B[n] and the end edge C[n] where the distance is the greatest.

As shown in FIG. 5(a), the processor 11 calculates the position of the midpoint D[n] between the start edge B[n] of the groove 40 to be the subject of depth calculation and the preceding end edge C[n−1]. The processor 11 determines, as the distance value of the start edge B[n], the median or average value of distance for a section between the start edge B[n] and the midpoint D[n].

As shown in FIG. 5(b), the processor 11 calculates the position of the midpoint D[n+1] between the end edge C[n] of the groove 40 to be the subject of depth calculation and the following start edge B[n+1]. The processor 11 determines, as the distance value of the end edge C[n], the median or average value of distance for a section between the end edge C[n] and the midpoint D[n+1]. From the value calculated in this way, it is possible to calculate the average value between the distance at the start edge B[n] and the distance at the end edge C[n].

As shown in FIG. 5(c), the processor 11 extracts the distance value at the position G[n] between the start edge B[n] and the end edge C[n] where the distance is the greatest. The processor 11 calculates, as the depth H[n] of groove 40, the difference between the average value (between the distance at the start edge B[n] and the distance at the end edge C[n]) and the distance value at the position G[n]. By performing this process for each candidate groove 40, it is possible to calculate the depth of each candidate groove 40.

Next, the processor 11 selects the groove (the first groove) with the deepest depth from among the plurality of candidate grooves 40 (Step S13). Using the value of the depth of the first groove, which is the deepest, the processor 11 selects candidate main grooves 41 from among the plurality of candidate grooves 40 (Step S14).

The processor 11 selects, as candidate main grooves 41, grooves whose depth is within a predetermined value Q (the first predetermined value) with respect to the depth of the first groove from among a plurality of candidate grooves 40. The predetermined value Q is 1.5 mm to 2.0 mm, for example, but is not limited thereto. Here, the predetermined value Q is 1.6 mm as an example.

The processor 11 selects the shallowest depth value from among the depths of the candidate main grooves 41. For example, suppose there are four candidate main grooves 41 with depths of 5.0 mm, 5.2 mm, 4.5 mm, and 4.1 mm. In this case, the processor 11 determines that the groove with a depth of 4.1 mm is the shallowest of the candidate main grooves 41, and selects the depth value of 4.1 mm. Thus, it is possible to detect the remaining amount of the main groove 41 with the tread wear indicator 44.

According to the present embodiment, it is possible to detect the depth of the shallowest main groove 41 from among the main grooves 41 and the sub-grooves 42 provided in the tread 31. By selecting the candidate main grooves 41 from among the plurality of candidate grooves 40, it is possible to suppress the erroneous detection of the depth of a sub-groove 42 as the depth of the shallowest main groove 41. By being able to determine the remaining amount of the main groove 41 provided with the tread wear indicator 44, it is possible to appropriately manage the condition of the tire 30.

The user can easily manage the condition of the tire 30 as there is no need for the user to look at the output data of the distance sensor 21, find the shallowest main groove 41 and determine its depth.

Note that, at the point where the first groove with the deepest depth is selected in Step S13, the process of detecting a plurality of candidate grooves 40 from the measurement data 50 (Step S12) may be performed again. In this case, the processor 11 updates the predetermined values A1 and A2 to the value obtained by multiplying the depth of the first groove by the first predetermined ratio. The first predetermined ratio is 30% to 50%, for example, but is not limited thereto. Here, the first predetermined ratio is 50% as an example. The processor 11 again executes the process of estimating the positions of the start edge B[n] and end edge C[n] using the updated predetermined values A1 and A2.

The processor 11 updates a plurality of candidate grooves 40 based on the positions of the re-estimated start edge B[n] and end edge C[n]. By updating the plurality of candidate grooves 40, it is possible to more accurately select candidate main grooves 41. The processor 11 selects, as candidate main grooves 41, grooves whose depth is within the first predetermined value Q with respect to the depth of the first groove from among the updated candidate grooves 40. The processor 11 selects the shallowest depth value from among the depths of the candidate main grooves 41. Thus, it is possible to detect the remaining amount of the main groove 41 provided with the tread wear indicator 44.

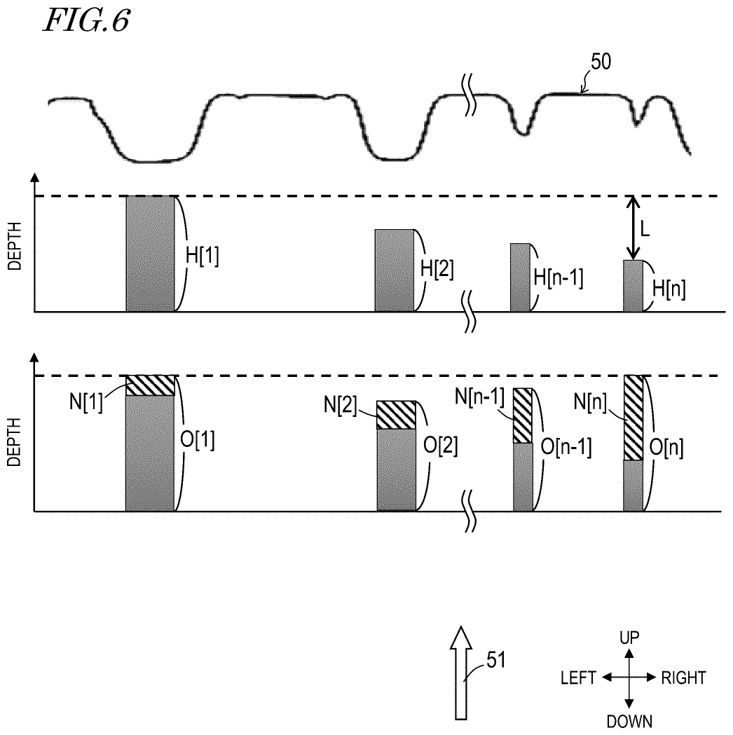

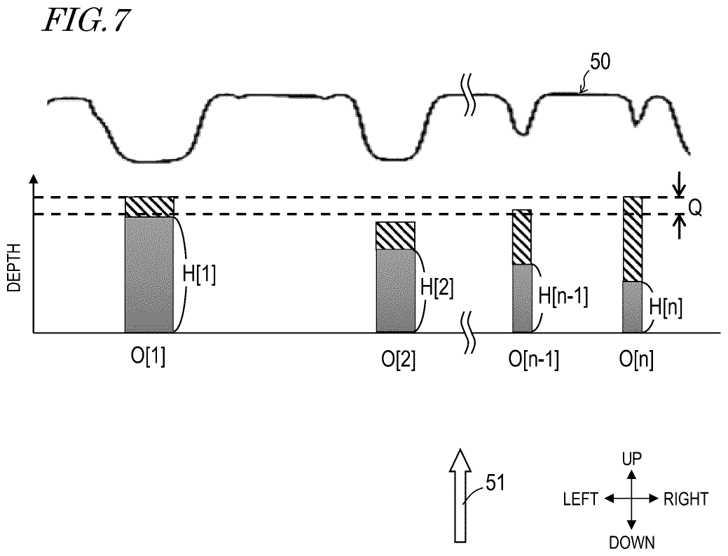

Next, the offset process in the detection of the depth of the main grooves 41 will be described. FIG. 6 and FIG. 7 are views showing the offset process in the detection of the depth of the main grooves 41. By performing the offset process, it is possible to suppress the shallowest main groove 41 from being excluded from candidate main grooves 41 even when the tire 30 is unevenly worn.

FIG. 6 shows the depths H[1] to H[n] of the candidate grooves 40. The processor 11 calculates the difference L between the depth H[1] of the first-detected groove and the depth H[n] of the last-detected groove, from among the plurality of grooves 40.

The processor 11 corrects the depth values of the candidate grooves 40 based on the difference L. For example, for each of the candidate grooves 40, the process calculates the value obtained by multiplying the difference L by the ratio M[n], and the calculated value is used as the offset amount N[n].

For example, suppose that the depth H[n] of the last-detected groove is shallower than the depth H[1] of the first-detected groove. In this case, for example, the ratio M[n] may be set so that the corrected depth value of the last-detected groove is close to the corrected depth value of the first-detected groove. For example, the ratio M[n] may be set so that the corrected depth value of the last-detected groove is generally equal to the corrected depth value of the first-detected groove. The ratio M[n] may be set so as to proportionally decrease from the last-detected groove to the first-detected groove. For grooves located between the first-detected groove and the last-detected grooves, the magnitude of the proportionally decreasing ratio M[n] is applied.

For example, the ratio M[n] may be given as M[n]=n/nₘₐₓ, where nₘₐₓ is the total number of candidate grooves 40. For example, where the total number of grooves is 5, M[n]=n/nₘₐₓ=5/5=1.0 for the last-detected groove. M[n]=n/nₘₐₓ=4/5=0.8 for the groove detected second to last. M[n]=n/nₘₐₓ=3/5=0.6 for the groove detected third to last. M[n]=n/nₘₐₓ=2/5=0.4 for the groove detected fourth to last. M[n]=n/nₘₐₓ=1/5=0.2 for the groove detected fifth to last (i.e., the first-detected groove).

The processor 11 adds the offset amounts N[1] to N[n] to the depths H[1] to H[n] of the candidate grooves 40. The lower part of FIG. 6 shows the depths O[1] to O[n] of the candidate grooves 40 after the offset amounts are added.

The processor 11 selects the largest value from among the depths O[1] to O[n], and uses that value as the depth value of the deepest first groove. In the example shown in FIG. 6 and FIG. 7, the depth O[1] is used as the depth of the deepest first groove. The processor 11 selects candidate main grooves 41 from among the candidate grooves 40 using the depth value O[1].

The processor 11 selects, as candidate main grooves 41, grooves whose depth is within the predetermined value Q with respect to the depth O[1] of the first groove from among the candidate grooves 40. In the example shown in FIG. 7, the groove with the depth O[1], the groove with the depth O[n−1], and the groove with the depth O[n] are selected as candidate main grooves 41. The processor 11 selects the shallowest depth value f original depths H[1], H[n−1], and H[n], excluding the offset amount. In the example shown in FIG. 7, H[n] is selected as the shallowest depth value.

By performing the offset process as described above, it is possible to suppress the shallowest main groove 41 from being excluded from candidate main grooves 41 even when the tire 30 is unevenly worn.

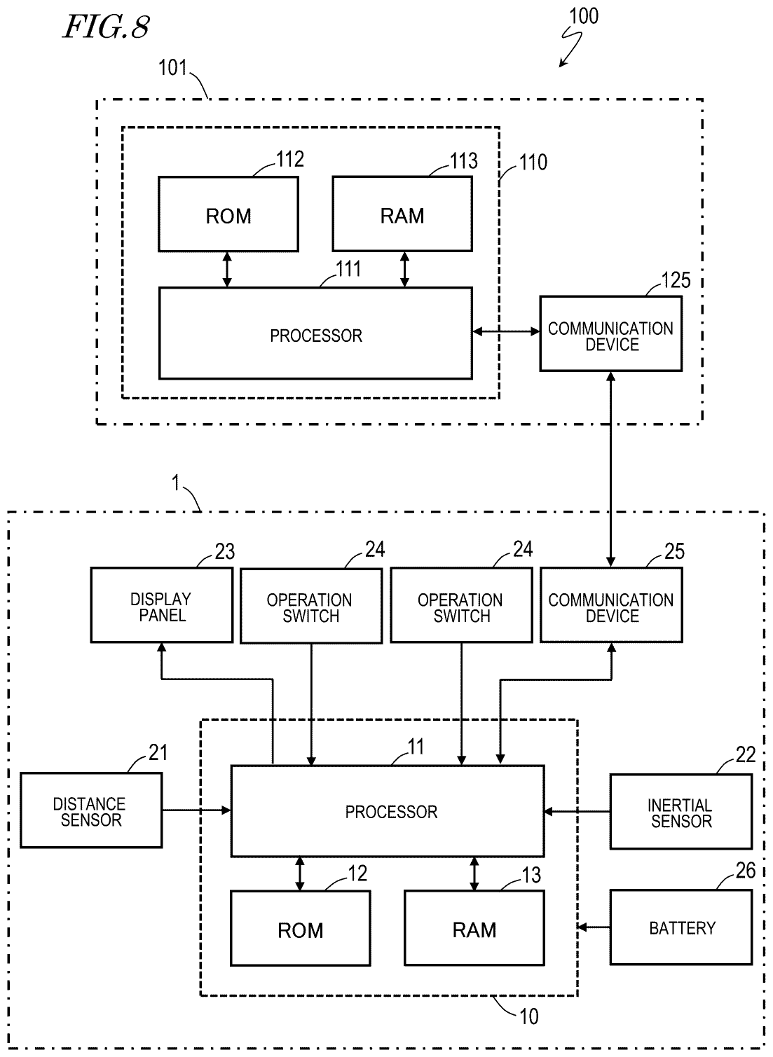

Noted that the offset process described above may be performed by a device external to the tire groove measuring device 1. FIG. 8 is a block diagram showing a tire groove measuring system 100 according to an embodiment of the present invention.

The tire groove measuring system 100 includes the tire groove measuring device 1 and an external device 101. The external device 101 is, for example, a server computer or a user terminal device. The user terminal device is, for example, a personal computer or a tablet computer.

The external device 101 includes a processing device 110 and a communication device 125. The processing device 110 includes a processor 111 and a recording medium such as a ROM 112 and a RAM 113. The description of the processor 111, the ROM 112, the RAM 113 and the communication device 125 will be omitted as it is redundant with the description of the processor 11, the ROM 12, the RAM 13 and the communication device 25 of the tire groove measuring device 1.

The processor 111 of the external device 101 performs the process of the processor 11 described above. This also provides the same effect as the above.

While the tire groove measuring device 1 is of a hand-held type in the description of the embodiment above, the tire groove measuring device 1 may also be of a stationary type. Even in a form where the tire groove measuring device 1 is fixed at an arbitrary location, it is possible to detect the depth of the shallowest main groove 41 from among the grooves 40 provided in the tread 31. By being able to determine the remaining amount of the main groove 41 provided with the tread wear indicator 44, it is possible to appropriately manage the condition of the tire 30.

An embodiment of the present invention has been described above.

The tire groove measuring device 1 according to one embodiment of the present invention is a hand-held tire groove measuring device 1 that a user moves along a tread 31 of a tire 30 to measure grooves 40 provided in the tread 31 of the tire 30, including: a distance sensor 21 that detects a distance between the tire 30 and the tire groove measuring device 1; and a processing device 10 that calculates depths of the grooves 40 based on output data of the distance sensor 21, wherein: the tread 31 of the tire 30 is provided with main grooves 41 having a tread wear indicator 44 and sub-grooves 42 not having a tread wear indicator 44; and the processing device 10 is configured to: detect candidate grooves 40 based on the output data of the distance sensor 21; select a first groove with a deepest depth from among the plurality of candidate grooves 40; select, as candidate main grooves 41, grooves 40 whose depth is within a first predetermined value Q with respect to the depth of the first groove from among the candidate grooves 40; and select a shallowest depth value from among depths of the candidate main grooves 41.

The tire groove measuring device 1 according to one embodiment of the present invention is a hand-held tire groove measuring device that the user moves along the tread 31 of the tire 30. The grooves 40 can be measured while the vehicle is stopped at an arbitrary location, and it is therefore possible to improve the user convenience.

According to one embodiment of the present invention, it is possible to detect the depth of the shallowest main groove 41 from among the main grooves 41 and the sub-grooves 42 provided in the tread 31. By selecting candidate main grooves 41 from among a plurality of candidate grooves 41, it is possible to suppress the detection of the depth of a sub-groove 42 as the depth of the shallowest main groove 41. By being able to determine the remaining amount of the main groove 41 provided with the tread wear indicator 44, it is possible to appropriately manage the condition of the tire 30.

The user can easily manage the condition of the tire 30 as there is no need for the user to look at the output data of the distance sensor 21, find the shallowest main groove 41 and determine its depth.

In one embodiment, the processing device 10 may be configured to: estimate a position where an amount of increase in distance indicated by the output data is equal to a second predetermined value A1 as a position of a start edge B[n] of a groove 40; and estimate a position where an amount of decrease in distance indicated by the output data is equal to a third predetermined value A2 as a position of an end edge C[n] of the groove 40.

Thus, it is possible to detect a plurality of candidate grooves 40 using the output data of the distance sensor 21.

In one embodiment, the processing device 10 may be configured to: calculate an average value between a distance at the start edge B[n] and a distance at the end edge C[n] indicated by the output data; and calculate, as a depth of the groove 40, a difference between the average value and a distance at a position between the start edge B[n] and the end edge C[n] where the distance is greatest.

Thus, it is possible to calculate the depths of a plurality of candidate grooves 40.

In one embodiment, the processing device 10 may be configured to: update the second and third predetermined values A1 and A2 to a value obtained by multiplying the depth of the first groove by a first predetermined ratio; and re-estimate the positions of the start edge B[n] and the end edge C[n] of the groove 40 using the updated second and third predetermined values A1 and A2.

Thus, it is possible to more accurately select candidate main grooves 41 from among a plurality of candidate grooves 40.

In one embodiment, the processing device 10 may be configured to: update the plurality of candidate grooves 40 based on the positions of the start edge B[n] and the end edge C[n] of the grooves 40 estimated using the updated second and third predetermined values A1 and A2; and select, as candidate main grooves 41, grooves 40 whose depth is within the first predetermined value Q with respect to the depth of the first groove.

Thus, it is possible to more accurately select candidate main grooves 41.

In one embodiment, the processing device 10 may be configured to: calculate a difference L between a depth of a first-detected groove 40 and a depth of a last-detected groove 40, from among the plurality of candidate grooves 40; correct depth values of the plurality of candidate grooves 40 based on the difference L between the depth of the first-detected groove 40 and the depth of the last-detected groove 40; and select candidate main grooves 41 based on the corrected depths of the plurality of candidate grooves 40.

Thus, it is possible to suppress the shallowest main groove 41 from being excluded from candidate main grooves 41 even when the tire 30 is unevenly worn.

In one embodiment, the tire groove measuring device 1 may further include an inertial sensor 22 that detects movement of the tire groove measuring device 1, wherein the processing device 10 corrects the output data of the distance sensor 21 based on output data of the inertial sensor 22.

From the output data of the inertial sensor 22, it is possible to calculate the amount of movement of the tire groove measuring device 1 and detect the degree of tilt of the tire groove measuring device 1. By correcting the output data of the distance sensor 21 using the output data of the inertial sensor 22, it is possible to reduce the disturbance of the measurement data caused by vibration, hand shake, etc., of the tire groove measuring device 1 during the scan.

In one embodiment, the distance sensor 21 may be a laser distance sensor.

Thus, there is no need to insert a probe such as a gauge into the grooves 40 of the tire 30, and it is possible to measure the grooves 40 of the tire 30 with high accuracy in a short time.

The tire groove measuring system 100 according to one embodiment of the present invention is a tire groove measuring system 100 that measures grooves 40 provided in a tread 31 of a tire 30 using a hand-held tire groove measuring device 1 that a user moves along the tread 31 of the tire 30, including: a distance sensor 21 provided in the tire groove measuring device 1 that detects a distance between the tire 30 and the tire groove measuring device 1; and a processing device 10 that calculates depths of the grooves 40 based on output data of the distance sensor 21, wherein: the tread 31 of the tire 30 is provided with main grooves 41 having a tread wear indicator 44 and sub-grooves 42 not having a tread wear indicator 44; and the processing device 10 is configured to: detect a plurality of candidate grooves 40 based on the output data of the distance sensor 21; select a first groove with a deepest depth from among the plurality of candidate grooves 40; select, as candidate main grooves 41, grooves 40 whose depth is within a first predetermined value Q with respect to the depth of the first groove from among the candidate grooves 40; and select a shallowest depth value from among depths of the candidate main grooves 41.

The tire groove measuring device 1 according to one embodiment of the present invention is a hand-held tire groove measuring device that the user moves along the tread 31 of the tire 30. The grooves 40 can be measured while the vehicle is stopped at an arbitrary location, and it is therefore possible to improve the user convenience.

According to one embodiment of the present invention, it is possible to detect the depth of the shallowest main groove 41 from among the main grooves 41 and the sub-grooves 42 provided in the tread 31. By selecting candidate main grooves 41 from among a plurality of candidate grooves 41, it is possible to suppress the detection of the depth of a sub-groove 42 as the depth of the shallowest main groove 41. By being able to determine the remaining amount of the main groove 41 provided with the tread wear indicator 44, it is possible to appropriately manage the condition of the tire 30.

The user can easily manage the condition of the tire 30 as there is no need for the user to look at the output data of the distance sensor 21, find the shallowest main groove 41 and determine its depth.

The tire groove measuring method according to one embodiment of the present invention is a tire groove measuring method that measures grooves 40 provided in a tread 31 of a tire 30 by using a hand-held tire groove measuring device 1 that a user moves along the tread 31 of the tire 30, wherein: the tread 31 of the tire 30 is provided with main grooves 41 having a tread wear indicator 44 and sub-grooves 42 not having a tread wear indicator 44; and the tire groove measuring method includes: detecting a distance between the tire 30 and the tire groove measuring device 1 using a distance sensor 21; detecting a plurality of candidate grooves 40 based on output data of the distance sensor 21; selecting a first groove with a deepest depth from among the plurality of candidate grooves 40; selecting, as candidate main grooves 41, grooves 40 whose depth is within a first predetermined value Q with respect to the depth of the first groove from among the candidate grooves 40; and selecting a shallowest depth value from among depths of the candidate main grooves 41.

The tire groove measuring device 1 according to one embodiment of the present invention is a hand-held tire groove measuring device that the user moves along the tread 31 of the tire 30. The grooves 40 can be measured while the vehicle is stopped at an arbitrary location, and it is therefore possible to improve the user convenience.

According to one embodiment of the present invention, it is possible to detect the depth of the shallowest main groove 41 from among the main grooves 41 and the sub-grooves 42 provided in the tread 31. By selecting candidate main grooves 41 from among a plurality of candidate grooves 41, it is possible to suppress the detection of the depth of a sub-groove 42 as the depth of the shallowest main groove 41. By being able to determine the remaining amount of the main groove 41 provided with the tread wear indicator 44, it is possible to appropriately manage the condition of the tire 30.

The user can easily manage the condition of the tire 30 as there is no need for the user to look at the output data of the distance sensor 21, find the shallowest main groove 41 and determine its depth.

The description of the embodiment above merely illustrates the present invention and does not limit the present invention. Other embodiments are possible that each employ a combination of elements described in the embodiment above. Modifications, replacements, additions, omissions, etc., can be made to the present invention without departing from the scope defined by the claims and equivalents thereto.

### INDUSTRIAL APPLICABILITY

This invention is particularly useful in the technical field of tire groove measurement.

REFERENCE SIGNS LIST

1: Tire groove measuring device, 10: Processing
device, 11: Processor, 12: ROM, 13: RAM, 21: Distance sensor,
22: Inertial sensor, 23: Display panel, 24: Operation switch,
25: Communication device, 26: Battery, 30: Tire, 31: Tread,
40: Groove, 41: Main groove, 42: Sub-groove, 44: Tread wear
indicator, 50: Measurement data, 100: Tire groove measuring
system, 101: External device, 110: Processing device, 111:
Processor, 112: ROM, 113: RAM, 125: Communication device

1. A hand-held tire groove measuring device that a user moves along a tread of a tire to measure grooves provided in the tread of the tire, comprising:
a distance sensor that detects a distance between the tire and the tire groove measuring device; and
a processor that calculates depths of the grooves based on output data of the distance sensor, wherein:
the tread of the tire is provided with main grooves having a tread wear indicator and sub-grooves not having a tread wear indicator;
the processor is configured to:
detect a plurality of candidate grooves based on the output data of the distance sensor;
select a first groove with a deepest depth from among the plurality of candidate grooves;
select, as candidate main grooves, grooves whose depth is within a first predetermined value with respect to the depth of the first groove from among the plurality of candidate grooves; and
select a shallowest depth value from among depths of the candidate main grooves.

2. The tire groove measuring device according to claim 1, wherein the processor is configured to: estimate a position where an amount of increase in distance indicated by the output data is equal to a second predetermined value as a position of a start edge of a groove; and estimate a position where an amount of decrease in distance indicated by the output data is equal to a third predetermined value as a position of an end edge of the groove.

3. The tire groove measuring device according to claim 2, wherein:
the processor is configured to:
calculate an average value between a distance at the start edge and a distance at the end edge indicated by the output data; and
calculate, as a depth of the groove, a difference between the average value and a distance at a position between the start edge and the end edge where the distance is greatest.

4. The tire groove measuring device according to claim 3, wherein:
the processor is configured to:
update the second and third predetermined values to a value obtained by multiplying the depth of the first groove by a first predetermined ratio; and
re-estimate the positions of the start edge and the end edge of the groove using the updated second and third predetermined values.

5. The tire groove measuring device according to claim 4, wherein the processor is configured to: update the plurality of candidate grooves based on the positions of the start edge and the end edge of the grooves estimated using the updated second and third predetermined values; and select, as candidate main grooves, grooves whose depth is within the first predetermined value with respect to the depth of the first groove.

6. The tire groove measuring device according to claim 1, wherein:
the processor is configured to:
calculate a difference between a depth of a first-detected groove and a depth of a last-detected groove, from among the plurality of candidate grooves;
correct depth values of the plurality of candidate grooves based on the difference between the depth of the first-detected groove and the depth of the last-detected groove; and
select candidate main grooves based on the corrected depths of the plurality of candidate grooves.

7. The tire groove measuring device according to claim 1, further comprising:
an inertial sensor that detects movement of the tire groove measuring device,
wherein the processor corrects the output data of the distance sensor based on output data of the inertial sensor.

8. The tire groove measuring device according to claim 1, wherein the distance sensor is a laser distance sensor.

9. A tire groove measuring system that measures grooves provided in a tread of a tire using a hand-held tire groove measuring device that a user moves along the tread of the tire, comprising:
a distance sensor provided in the tire groove measuring device that detects a distance between the tire and the tire groove measuring device; and
a processor that calculates depths of the grooves based on output data of the distance sensor, wherein:
the tread of the tire is provided with main grooves having a tread wear indicator and sub-grooves not having a tread wear indicator; and
the processor is configured to:
detect a plurality of candidate grooves based on the output data of the distance sensor;
select a first groove with a deepest depth from among the plurality of candidate grooves;
select, as candidate main grooves, grooves whose depth is within a first predetermined value with respect to the depth of the first groove from among the plurality of candidate grooves; and
select a shallowest depth value from among depths of the candidate main grooves.

10. A tire groove measuring method that measures grooves provided in a tread of a tire by using a hand-held tire groove measuring device that a user moves along the tread of the tire, wherein:
the tread of the tire is provided with main grooves having a tread wear indicator and sub-grooves not having a tread wear indicator;
and the tire groove measuring method comprises:
detecting a distance between the tire and the tire groove measuring device using a distance sensor;
detecting a plurality of candidate grooves based on output data of the distance sensor;
selecting a first groove with a deepest depth from among the plurality of candidate grooves;
selecting, as candidate main grooves, grooves whose depth is within a first predetermined value with respect to the depth of the first groove from among the plurality of candidate grooves; and
selecting a shallowest depth value from among depths of the candidate main grooves.
